(19) United States
(12) Patent Application Publication
(10) Pub. No.: US 2009/0132816 A1
(43) Pub. Date: May 21, 2009

(54) PC on USB drive or cell phone

(75) Inventor: Richard M. Lee, San Jose, CA (US)

Correspondence Address: Leland L. Chan;Lockheed Martin IS&S, P. O. Box 49041, San Jose, CA, 95161-9041, US

(73) Assignee: Lockheed Martin Corporation

(21) Appl. No.: 11/985,408

(22) Filed: Nov. 15, 2007

(51) Int. Cl. H04L 9/00; H04L 9/32

(52) U.S. Cl. 713/164; 713/186

(57) ABSTRACT

Disclosed are virtual, personal computers implemented on USB drive, cell phone platforms, or other small portable computing platform. Exemplary personal computers include a nanokernel or minikernel configured to boot when connected to a host computer. A memory is provide for storing the nanokernel or minikernel, along with encrypted data, secure keys and certificates, and one or more software applications. The nanokernel or minikernel is configured to allow selected stored software applications to run on the host computer and execute on the user data stored in the memory when the computing apparatus is connected to the host computer and booted. The nanokernel or minikernel is also configured to prevent any other application from executing on user data stored in the memory. The TPM provides the mechanism to seal and authenticate the compute environment of the host computer its components and/or the USB drive et al itself. The contents of the virtual, personal computer are meant to execute on the host computer, but have persistent, encrypted storage on the USB drive, cell phone platforms, or other small portable computing platform which may have additional biometric identification.

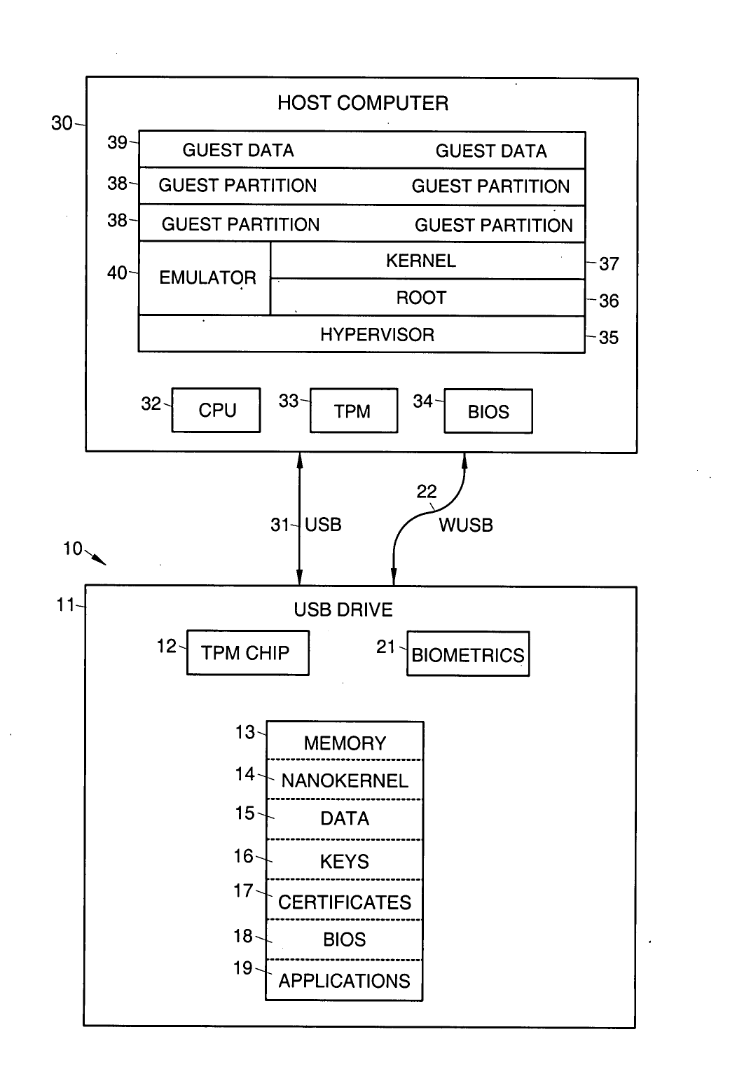

### BACKGROUND

The present invention relates generally to portable virtual, personal computers, and more particular, to portable virtual, personal computers implemented on a host computer or its kernel, root, hypervisor and/or a virtual memory machine (VMM) or guest partition, and populated with a computing environment from a USB drive, cell phone platform, or other portable device, such as a personal digital assistant (PDA).

There are existing secure USB drives offered by companies such as Kingston DataTraveler Secure, SanDisk, and IronKey Secure Flash Drive and Internet Protection. However, existing secure USB drives only provide for encrypted data stored on the USB drive, and typically are encrypted such that they must be utilized on the same computer that originally encrypted the device. While the data is encrypted and portable, it is not usable across different computers (i.e. internet café, work, home), and the data is not sealed (i.e. data can be decrypted, and shared as allowed). The challenge is how to secure the data while it is in use on a host computer and not have its integrity compromised (i.e. user data is left on a C drive or other public area such as the desktop and is no longer encrypted).

The concept implemented in the present invention is vaguely similar to the GSM mobile cell phone concept where all GSM infrastructure can accept a subscriber identity module (SIM) card that one can “plug and play” into any GSM phone to configure it as a personal phone. However the GSM mobile cell phone concept does not implement personal computing functionality.

There is a need for a virtual, secure computing environment comprising personal computers that are implemented on USB drive or cell phone platforms or similar portable devices.

### BRIEF DESCRIPTION OF THE DRAWINGS

The various features and advantages of the present invention may be more readily understood with reference to the following detailed description taken in conjunction with the accompanying drawings, wherein like reference numerals designate like structural elements, and in which the sole drawing FIGURE illustrates an exemplary personal computer implemented on USB drive.

### DETAILED DESCRIPTION

Disclosed is a virtual secure computing environment 10 comprising a portable personal computer 10 implemented on a USB drive 11, or embedded into a cell phone or other portable device. Although the specific portable personal computer 10 described below is embodied in a USB drive 11, the portable personal computer 10 may readily be embodied in a cell phone, or other portable device. The personal computer 10 provides for an ultimate trusted personal computing device that its contents are secured, sealed, authenticated and portable such that a user may carry, and which may be used almost anywhere. The specific portable personal computer 10 is acting as the secure boot device to configure (in part or in its entirety) the entire host computer 30, the kernel 37, the root 36, the hypervisor 35, or any VMM or Guest Partition 38, and all User data 39, applications, etc. from a secured, sealed, authenticated and portable device 10.

The disclosed virtual, personal computer 10, which is preferably implemented on a USB drive 11 or a cell phone, for example, is a “plug and play device” that enables a person to carry an entire personal computing environment around with him or her so that the data and computing environment is available for use by the person at all times. The personal computer 10 implemented on a USB drive 11 (or cell phone) may be used to purchase items (vending machines, shopping, gas, etc.), perform banking transactions, provide identification (such as a CAC card—i.e., electronic dog tag), as a FastPass device at toll booths or airport, as a device that can start a car, open a car door, store medical information, replace credit cards, interrogate a USB device, and provide phone functionalities, for example.

Referring to the sole drawing FIGURE, it illustrates an exemplary virtual secure computing environment 10, or portable personal computer 10, that is implemented on a USB drive 11, cell phone or other portable device and which may incorporate a variety of features. For example, an exemplary personal computer 10 implemented as the USB drive 11 includes a Trusted Platform Module (TPM) chip 12 to provide hardware secure encryption and authentication keys and certificates to seal data and enable authentication of a compute environment from a portable device. This is embedded in the USB drive 11, (or the cell phone, or other portable device). This allows a user to ascertain if the host computer 30 is in the same state of trust as the last time the user utilized the host computer 30 as well as to ensure the hypervisor 35, the root 36, the kernel 37, the guest partition 38, and/or the guest data 39 are trusted and secure.

The portable personal computer 10 is designed to implement Trusted Computing Group (TCG) specifications to ensure a secure computing environment, and is designed to support secure computing environments using virtualization technologies to create a virtual, secure environment on the host computer 30 from the portable personal computer 10. This environment may utilize a multi-core CPU to boost processing power, trusted platform modules (TPM) to secure keys and certificates for authentication, and virtualization technologies on the Host Computer 30 to create logical abstractions apart from the physical characteristic or location of the portable personal computer 10. In the event the Host Computer 30, does not have or support a TPM functionality, the TPM on the portable personal computer 10 can be used to seal and authenticate the environment on the Host Computer 30 in addition to the USB drive 11 itself.

The USB drive 11 includes a memory 13 to store a nanokernel 14 or minikernel 14, encrypted data 15, secure keys 16, and certificates 17, for example. The memory 13 is preferably configured in accordance with Moore's law so it is relatively inexpensive and may be scaled to meet increasing memory demands and performance requirements. Secure BIOS 18 (basic input/output system 18) may be optionally included in the USB drive 11 or a regular BIOS depending on the trust level desired.

The BIOS 18 comprises firmware run by the host computer 30 and loaded from the USB drive 11 in addition to the nanokernel 14 or minikernel 14 when it is connected to a host computer 30. The primary function of the BIOS 18 is to identify and initiate component hardware comprising the USB drive 11 as well as to authenticate the target compute environment to be run on the host computer 30 in the kernel 37, root 36, hypervisor 35 or guest partition 38. This is to secure and authenticate the USB drive 11 so that software programs stored on the USB drive 11 can load, execute, and assume control of the USB drive 11 as well as to secure and authenticate the host computer 30 environment. The main idea is you have control over the portable computer 10, but not necessarily the host computer 30. If you can load the components that will run on the host computer 30 from your portable computer 10, then you have a higher degree of trust built upon a secure and authenticate boot stream that you configured, in whole or in part, from your portable computer 10.

The kernel 37, root 36, hypervisor 35 or guest partition 38 and guest data 39 is booted from the nanokernel 14 or minikernel 14 (and the BIOS 18) depending on user boot preferences configured for a cold boot (power up boot sequence) or a warm boot (plug and play) of the USB drive 11. This feature is not present in any known portable USB or cell phone device. The Apple IPOD™, for example, probably has some type of kernel that is used for booting purposes. Also, an article posted at http://linuxdevices.com/news/NS8513245752.html entitled “World's first single-core Linux phone demoed” mentions the possible development of a kernel for a cell phone. However, the presently-disclosed nanokernel 14 or minikernel 14 is designed to boot when connected to a host PC, which is not done with an IPOD or a cell phone; these devices boot themselves.

Any electronic processing device needs to be able to boot itself, and as the above-cited article indicates, there are form factor benefits to simplify the computational needs and reduce the number of components required to do this. By converging to one processor, the present personal computer 10 extends the portability of the user compute experience by allowing a user compute environment to be loaded into a host computer 30 guest partition 38 to create a unique compute environment seamlessly across various technologies. With the virtualization capabilities emerging on the host computer 30, it will be possible to load any operating system into the guest partition 38—the smaller the better, so that it takes up less space and overhead.

Emulators 40 in the kernel 37 or the root 36 will take care of making other instruction sets execute on an x86 architecture, for example, traditionally prevalent on desktop and laptop host computers 30. This concept enables plug and play capability from the cell phone or USB drive 11 to any host computer 30 in a trusted, secure, and authenticated fashion while remaining transparent to the user. If a user is not carrying a cell phone, the compute environment 10 may be copied to the USB device 11, and taken on a trip, and loaded into a host computer 30. When the user is done updating documents, etc., then it is stored back in the USB device 11 to synchronize at a later time with another trusted portable computer 10 (desktop, laptop, PDA, cell phone, etc.).

The key here is that it is the user's own virtual compute environment and its entire content is carried around with the user in a trusted, secure, authenticated, and portable manner that can execute on any host computer 30. There is nothing left behind on the host computer 30 after the user has completed a compute session. This enables the ultimate capability to enforce DRM (Data Rights Management), since the user's content is uniquely identifiable (i.e., encrypted and traceable to the user's TPM (Trusted Platform Module) on his or her USB drive 11, and the content can only be decrypted with the user's specific TPM). This ensures to a distributor of content (i.e., music, movie, software, etc.) that only the authorized user is using the content since it cannot be shared by other users (i.e., the guest partition 38, guest data 39, and perhaps the kernel 37 are torn down after the session is over).

The nanokernel 14 or minikernel 14 is self contained and provides for secure booting of the root 36, kernel 37, hypervisor 35 and/or Guest Partition 38 and Guest Data 39 from the USB drive 11 (personal computer 10) when connected to a host computer 30. The USB drive 11 is plugged into any available host computer 30 by way of a USB port 31 or wireless USB interface (WUSB) 22 may also be supported on the host computer 30 so that it can utilize the host computer's CPU 32, and infrastructure. The nanokernel 14 or minikernel 14 on the USB drive 11 is loaded into the CPU 32 of the host computer 30 to perform processing on the host computer 30, and all input/output functions are performed using the secure USB drive 11. Thus, no data is stored on the host computer 30 outside of the guest partition 39 when the USB drive 11 is connected to the host computer 30 unless the kernel 37, root 36 and/or hypervisor 35 are also installed from the USB drive 11. If so, they too could be removed.

One aspect of the present portable personal computer 10 is that the nanokernel 14 or minikernel 14 is configured with one or more specifically allowed applications 19 that are stored on and loaded from the USB drive 11 to provide a “white list” of applications that are trusted to run on the host computer 30 typically in the guest partition 38. The secure nanokernel 14 preferably only allows the specific applications 19 to be run on the host computer 30 and access or execute on data stored in the guest data 39 and shadowed or mapped to the memory 13 of the USB drive 11. Any other application 19 is prevented from executing on the data 15 stored on the secure USB drive 11.

Biometric devices 21 (voiceprint, fingerprint, heartbeat, face recognition, etc.) may be employed to identify a person attempting to use the personal computer 11 (USB drive 11 or cell phone). For example, a USB drive 11 may include a fingerprint scanner 21 and/or a heartbeat sensor 21, while a cell phone may include voice and/or facial recognition apparatus 21.

As discussed above, there are two preferred form factors for the virtual secure computing environment 10 or portable personal computer 10. As was described above, one form factor looks like a USB drive 11 (such as a thumb drive, for example) but contains everything a user needs to work in a “secure, virtual” computing environment. The concept is similar to a GSM phone where a person can use any phone by inserting his or her GSM SIM chip to identify and configure the host phone to recognize the user. For example, the secure USB drive 11 would plug into any host computer 30, but only be able to use the specific nanokernel, applications, and disk space contained in the USB drive 11 and perform all work in an encrypted fashion. The other form factor may look like a cell phone or other portable device which includes the above-described features, but also include a USB interface or connector to allow the user to hook up to the USB port 31 of the host computer 30. In addition, the wireless USB interface 22 may also be included in the cell phone or other portable device 11. Additional communications paths could be enabled by a phone call or wifi connection to allow access to a local area network (LAN) or wide area network (WAN). This connection may or may not be encrypted as well.

As discussed above, while there are secure USB drives offered by companies such as Kingston DataTraveler Secure, SanDisk, and IronKey Secure Flash Drive and Internet Protection, they only focus on encrypting the data stored on the USB drive. The portable personal computer 10 implemented on a USB drive 11, or cell phone, leverages this type of technology for data storage and encryption, but also adds additional capabilities including a personal trusted nanokernel 14 or minikernel 14 and a predetermined number of applications 19 that the user or session is allowed to run. The personal computer 10 may readily be configured to support multiple users as well as a Multi-Level Security environment by enabling different configurations to be loaded into separate guest partitions 38 and their corresponding guest data 39.

The personal computer 10 implemented on a USB drive 11, or cell phone, improves upon existing portable computing solutions because it adds the capability to have a trusted nanokernel 14 or minikernel 14 and a predetermined number of applications 19 that the user or session can execute against guest data 39 in the guest partition 38 enabling portability of compute environments in a trusted, secure, authenticated manner across various devices. For example, the personal computer 10 may be configured to support multiple users and support a Multi-Level Security environment, not just encrypt data stored on the USB drive. The user's entire computing environment is virtually run from the USB drive 11 or cell phone.

Essentially, a user has everything he or she needs to perform secure computing at their fingertips, and the user can go to any Internet Café or kiosk, for example, to utilize a USB port 31 on a host computer 30 to provide a computing platform without having to carry around a laptop computer. The personal computer 10 may be used to replace commonly-used phones on airplanes with wireless USB connections 22 to a central computer 30 to allow multiple virtual environments (i.e., one USB connection per user) to perform computing with a wireless personal computer 10 such as the above-described USB drive 11 or cell phone. The personal computer 10 may embody computer forensics and biometric databases to add a fourth dimension to evaluate a computing environment. For example, some automation may be implemented in the nanokernel 14 or minikernel 14 of the personal computer 10 to make a “judgment” as to whether or not a host computer 30 is “trustworthy” to host the personal computer 10 implemented on the USB drive 11 or cell phone.

Thus, a personal computer implemented on USB drive or cell phone platforms has been disclosed. It is to be understood that the above-described embodiments are merely illustrative of some of the many specific embodiments that represent applications of the principles discussed above. Clearly, numerous and other arrangements can be readily devised by those skilled in the art without departing from the scope of the invention.

What is claimed is:

1. Computing apparatus comprising:
basic input/output system (BIOS) configured to boot when the apparatus is connected to a host computer and/or loaded into a root, kernel, hypervisor or guest partition;
a memory for storing the BIOS;
one or more software applications stored in the memory;
encrypted user data stored in the memory;
one or more secure keys and certificates stored in the memory using a trusted-platform-module-like device to seal and authenticate an environment;
and wherein the nanokernel or minikernel is configured to allow preselected software applications to run on the host computer and execute on encrypted user data stored in the memory when the computing apparatus is connected to the host computer and booted, and wherein the nanokernel or minikernel is configured to prevent any other application from executing on the encrypted user data stored in the memory.

2. The apparatus recited in claim 1 which is configured as a USB drive.

3. The apparatus recited in claim 1 which is configured as a cell phone.

4. The apparatus recited in claim 1 further comprising a Trusted Platform Module (TPM) chip that provides hardware secure encryption and authentication keys and certificates for sealing and authentication.

5. The apparatus recited in claim 1 further comprising biometric identification apparatus to identify a person attempting to use the apparatus.

6. The apparatus recited in claim 5 wherein the one or more biometric identification apparatus comprises voiceprint identification apparatus.

7. The apparatus recited in claim 6 wherein the one or more biometric identification apparatus comprises fingerprint identification apparatus.

8. The apparatus recited in claim 6 wherein the one or more biometric identification apparatus comprises heartbeat identification apparatus.

9. The apparatus recited in claim 1 wherein the one or more biometric identification apparatus comprises facial recognition apparatus.

10. The apparatus recited in claim 1 further comprising a wireless USB interface.

11. The apparatus recited in claim 1 which is configured to support multiple users.

12. The apparatus recited in claim 1 which is configured to support a multi-level security environment.

13. The apparatus recited in claim 1 which is configured to support trusted, secure, authenticated remote load and execution of the root, kernel, hypervisor, or guest partition and guest data in support of trusted virtual computing.
